(19) United States
(12) Patent Application Publication
(10) Pub. No.: US 2014/0157249 A1
(43) Pub. Date: Jun. 5, 2014

(54) METHOD AND SYSTEM FOR UPDATING SOFTWARE IN A MEDIA CONTENT DELIVERY SYSTEM

(71) Applicant: Liberty Global Europe Holding B.V, Schiphol-Rijk (NL)

(72) Inventors: Juan Ignacio Perez Diez, Amsterdam (NL); Eric Antonius Johannes Peeters, Alphen aan den Rijn (NL)

(73) Assignee: Liberty Global Europe Holding B.V., Schiphol-Rijk (NL)

(21) Appl. No.: 14/122,740

(22) PCT Filed: May 23, 2012
(86) PCT No.: PCT/NL2012/050359

§ 371 Date: Feb. 12, 2014

(30) Foreign Application Priority Data
May 27, 2011 (EP) 11167845.4

(51) Int. Cl. G06F 9/445

(52) U.S. Cl. CPC G06F 8/65
USPC 717/169

(57) ABSTRACT

Method and system for updating a software program stored and executable in an IP client (6). The IP client (6) is connected to a gateway server (4), which is connected to a head end facility (1) via a network (2). The method comprises interrogating an IP client (6) and receiving from the IP client (6) a current list of software program files including a latest version identifier for each of the software program files, receiving from the head end facility (1) a central list of latest version identifiers of software program files, and comparing the current list with the central list. If for a specific software program file a newer version identifier exists, the software program file associated with the newer version identifier is downloaded from the head end facility (1), and the newer version of the software program file is transferred to the IP client (6).

### FIELD OF THE INVENTION

The present invention relates to a method and system for updating software in a media content delivery system. More in particular, the present invention relates to a method for updating a software program stored and executable in an IP client, wherein the IP client is connected to a gateway server, and the gateway server is connected to a head end facility via a network.

### PRIOR ART

International patent publication WO 2006/018030 discloses a method, devices, and a computer program for synchronizing one or more software programs from a first device to a second device, in a general computing environment. The method comprises the steps of creating an application profile indicating software programs on the first device and indicating software program providing nodes from which these software programs are obtainable, providing the application profile to a synchronization manager, identifying by the synchronization manager the software programs and the software program providing nodes according to the application profile, requesting by the synchronization manager the software program providing nodes to transfer the software programs, and transferring the software programs from the software program providing nodes to the second device.

International patent publication WO 02/25438, discloses methods, systems, and configured storage media including a discovery agent for discovering software updates, discovering if a given computer can use the software update, and then updating the computers with the software as needed automatically across a network without storing the updates on an intermediate machine within the network. When a failure is detected, the rollout is stopped and the software can be automatically removed from those computers that were already updated. The software update can be stored originally at an address that is inaccessible through a network firewall by intermediately uploading the software update to an update computer which is not a part of the network but has access through the firewall, which is then used to distribute the update.

American patent publication US20100054266 discloses a method, device and module for optimizing remote management of home network devices. A home network is connected to an external network by a home network gateway device. The external network comprises an auto configuration server adapted and arranged to allow automatic configuration of a specifically adapted device in the home network, using the TR-069 protocol. The home network gateway device monitors TR-069 sessions between the auto configuration server and the specifically adapted devices, but does not act in the auto configuration settings.

### SUMMARY OF THE INVENTION

The present invention seeks to provide a method and system for automatically and efficiently updating a software program file being executed in a device in an IP based network, more specifically for updating software in set top boxes or like IP devices used in a media content delivery system.

According to the present invention, a method according to the preamble defined above is provided, wherein the head end facility forms part of a media content delivery system and is arranged to distribute media content to the IP client via the gateway server, the method comprising interrogating an IP client connected to the gateway server and receiving from the IP client a current list of software program files including a latest version identifier for each of the software program files, by the gateway server, receiving by the gateway server from the head end facility a central list of latest version identifiers of software program files executable by the IP client, comparing the current list with the central list by the gateway server, and if for a specific software program file a newer version identifier exists, downloading from the head end facility the software program file associated with the newer version identifier by the gateway server, and transferring the newer version of the software program file to the IP client by the gateway server.

In a further aspect, the present invention relates to a method for updating software program files in an IP client, the IP client being connected to a gateway server which is in communication with a head end facility through a network, the method comprising storing and broadcasting by the head end facility a list of latest versions available of software program files useable by an IP client, broadcasting in a scheduled manner the latest version of each software program file by the head end facility.

In an even further aspect, a method is provided for updating software program files in an IP client, the IP client being connected to a gateway server which is in communication with a head end facility through a network, the method comprising providing a list of software program files used in the IP client and the associated version identifiers upon request from the gateway server, receiving from the gateway server a software program file having a newer version identifier, and storing the software program file, by the IP client.

Furthermore, the present invention in a further aspect relates to a system for providing media content to one or more IP clients, the one or more IP clients being connected to a gateway server which is in communication with a head end facility through a network, wherein the IP client, gateway server and head end facility are arranged to perform the method according to the present invention embodiments. Also, a head end facility for providing media content to an IP client is related to a further aspect of the present invention, wherein the head end facility is arranged to implement the method according to the present invention embodiments. Finally, an IP client is provided in an even further aspect for providing media content to a user device, the IP client being connectable to a head end facility through a gateway server and a network, the IP client being arranged to execute the present invention embodiments.

### SHORT DESCRIPTION OF DRAWINGS

The present invention will be discussed in more detail below, using a number of exemplary embodiments, with reference to the attached drawings, in which

FIG. 1 shows a schematic view of a network configuration for a media content delivery system wherein the present invention embodiments can be implemented.

### DETAILED DESCRIPTION OF EXEMPLARY EMBODIMENTS

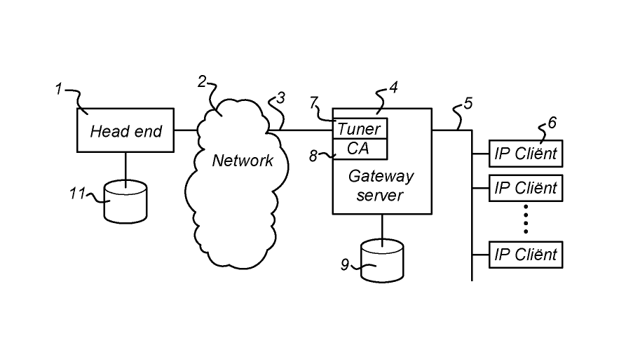

A block diagram is shown as a schematic view in FIG. 1, showing a network able to deliver broadcast content to a number of IP clients 6, such as television channels, pay-per-view programs or video-on-demand programs. A network 2 is used to distribute video content data in a broadcast manner, wherein the flow of data is controlled from a head end facility 1. Via a network connection 3 (e.g. coax or fiber connection) a gateway server 4 is connected to the network 2.

The head end facility 1 is providing multiple functions e.g. for a cable company, or a media content delivery company. Further infrastructure may be provided as part of or connected to the head end facility 1, such as data storage units, media content delivery interfaces, but also administrative oriented units, e.g. for billing purposes.

The gateway server 4 is connected to a local network 5, e.g. an IP based network, to which one or more IP clients 6 are connected. The gateway server 4 acts as a regular server in the local network 5, and therefore has knowledge on the IP clients 6 connected to the gateway server 4 at any moment in time. The gateway server 4 may be implemented as a so-called ‘head-less’ gateway or a ‘headed’ gateway. A ‘headed’ gateway includes video functionality (e.g. directly providing media content to a user device such as a television set) in addition to the functionality of a ‘head-less’ gateway.

The gateway server 4 is in an embodiment, a smart type of (cable) modem, comprising one or more tuners 7 allowing to receive (one or more) data streams from the network 2 via network connection 3. The gateway 4 may also be equipped with a memory unit 9, e.g. in the form of a hard disk, solid state memory, or a combination of both. Furthermore, the gateway server 4 is provided with a conditional access (CA) module 8, which is e.g. used to provide a user of the gateway server 4 and IP clients 6 with the services to which the user has subscribed.

The IP clients 6 are able to provide media content to a user device, such as a television set. The IP clients 6 are e.g. simplified set top boxes, which interface with a television set or monitor for displaying the content of the data streams received from the network 2. Note that the IP client 6 has no direct connection to a broadcast stream of data in the network 2, but receives the data via the gateway server 4. The IP clients 6 may also have other or additional functionality, e.g. acting as a radio tuner for listening to music broadcasts. The simplified set top boxes 6 are not provided with their own tuner(s) and conditional access modules, but rely on the gateway server 4 for receiving the data streams. The IP clients 6 can interface with the gateway server 4 for selection of e.g. a TV channel, or for selecting a VOD program.

For proper operation, the IP clients 6 are provided with one or more software programs for executing the desired functions, e.g. under control of a microprocessor.

The present invention embodiments allow to update the software programs in a very efficient manner. A software program may comprise an executable file, or a collection of files which together allow the IP client 6 to function properly (e.g. software module files, configuration files, etc.). As the gateway server 4 is functioning as server in the IP network 5, the gateway server 4 knows (and has stored) which IP clients 6 are connected to the gateway server 4.

In a first embodiment, the present invention relates to a method for updating a software program stored and executable in an IP client 6, wherein the IP client 6 is connected to a gateway server 4, and the gateway server 4 is connected to a head end facility 1 via a (broadcast) network 2. The following steps are executed:
interrogating an IP client 6 connected to the gateway server 4 and receiving from the IP client 6 a current list of software program files including a latest version identifier for each of the software program files,
receiving (and storing) from the head end facility 1 a central list of latest version identifiers of software program files executable by the IP client 6,
comparing the current list with the central list, and
if for a specific software program file a newer version identifier exists:
   downloading (i.e. receiving and storing) from the head end facility 1 the software program file associated with the newer version identifier, and
   transferring (or loading) the newer version of the software program file to the IP client 6.

All IP clients 6 can thus be provides with a new version of a software file in a very efficient manner, and without having to rely on a central head end facility 1 which serves a very large number of IP clients 6. The gateway server acts as an update agent for the IP clients 6 in the local (or home) network 5.

In a further embodiment, the network 2 is a content distribution network based on broadcast of data. The gateway server 4 receives the central list on a broadcast channel in the network 2, the correct parameters for tuning into the broadcast channel being known in the gateway server 4. The central list will comprise the identifiers of all possible program files being used in any of the IP clients 6 connected indirectly to the head end facility 1, as well as the associated latest version identifier.

The head end facility 1 is arranged to broadcast all software program files on a specific broadcast channel to which the gateway server 4 can tune in the network 2. By mere listening on that broadcast channel for the correct descriptor associated with the software program file, the gateway server 4 is able to receive the software program file associated with the newer version identifier on a broadcast channel in the network 2. Furthermore, the gateway server 4 can store the latest versions of each software program file locally (e.g. on memory unit 7) for later distribution to any of the IP clients 6 in its local network 5.

In a further embodiment, step of downloading the software program file is executed when the gateway server 4 is in an active state or in a stand-by state. The IP client 6 can then retrieve the new version of the software program files from the gateway server 4 whenever the IP client 6 goes into standby state. Updating of the software program files in the IP client 6 can only be performed when the IP client 6 is not actively running. The stand-by state of the gateway server 4 can be arranged to allow transfer of the software program file from the gateway server 4 to the IP client 6 during the stand-by state of the gateway server 4 and the IP client 6. Alternatively, an update is performed during an active state of the gateway server 4 and standby state of the IP client 6.

As an alternative, transferring the newer version of the software program file to the IP client 6 is executed at power-up of the IP client 6, which then first changes to a standby state allowing the update of the software program files. In this alternative, the IP client 6 (and gateway server 4) can be powered down completely after actual use, and update of the software is executed at wake-up of the IP client 6, which is more efficient from the viewpoint of energy efficiency.

As mentioned above, the gateway server 4 is the server in the local network 5. The IP clients 6 may be connected to the local network 5 using an IP based communication link for communicating with the gateway server 4, the actual implementation may be e.g. a coax connection (available in may homes), a WIFI connection or other wireless connection, an Ethernet connection, a powerLAN connection, etc.

In order to allow the use of cost-effective IP clients 6 in this context, some of the usual set top box functionality may be transferred to the gateway server 4. E.g. the gateway server 4 comprises one or more tuners 8. The gateway server 4 may furthermore comprise a conditional access unit 8, allowing to use all IP clients 6 behind the gateway server 4 to be treated as a single customer access entity.

In order to correctly implement the present invention embodiments, the functionality of the head end facility 1 enables to implement a method for updating software program files in an IP client 6, the IP client 6 being connected to a gateway server 4 which is in communication with a head end facility 1 through a (broadcast) network 2. The head end facility 1 is arranged to store and broadcast a list of latest versions available of software program files useable by an IP client 6, and to broadcast in a scheduled manner the latest version of each software program file in both steps, broadcasting is executed on a predetermined channel in the network 2. The scheduled manner allows to make sure that each and every software program file is regularly broadcast and can be received and stored by any gateway server 4 connected to the network 2.

Also from the viewpoint of the IP client 6 special features need to be implemented to allow a method for updating software program files in an IP client 6, the IP client 6 being connected to a gateway server 4 which is in communication with a head end facility 1 through a (broadcast) network 2. The IP client 6 is arranged to provide a list of software program files used in the IP client 6 and the associated version identifiers upon request from the gateway server 4, receiving from the gateway server 4 a software program file having a newer version identifier, and storing the software program file. In an embodiment receiving the software program file is executed when (or after) the IP client enters a standby mode, allowing to quickly transfer to amount of data associated with the software program file without interfering with receiving media content data during actual use of the IP client 6.

The present invention embodiments have been described above with reference to a number of exemplary embodiments as shown in the drawings. Modifications and alternative implementations of some parts or elements are possible, and are included in the scope of protection as defined in the appended claims.

What is claimed is:

1. A method for updating a software program stored and executable in an IP client, wherein the IP client is connected to a gateway server, and the gateway server is connected to a head end facility via a network, the head end facility forming part of a media content delivery system and being arranged to distribute media content to the IP client via the gateway server, comprising
interrogating an IP client connected to the gateway server and receiving from the IP client a current list of software program files including a latest version identifier for each of the software program files, by the gateway server,
receiving by the gateway server from the head end facility a central list of latest version identifiers of software program files executable by the IP client,
comparing the current list with the central list by the gateway server, and
if for a specific software program file a newer version identifier exists,
downloading from the head end facility the software program file associated with the newer version identifier by the gateway server, and
transferring the newer version of the software program file to the IP client by the gateway server.

2. The method of claim 1, wherein the gateway server receives the central list on a broadcast channel in the network.

3. The method of claim 1, wherein the gateway server receives the software program file associated with the newer version identifier on a broadcast channel in the network.

4. The method of claim 1, wherein the step of downloading the software program file is executed after the IP client is switched to a stand-by state.

5. The method of claim 4, wherein transferring the newer version of the software program file to the IP client is executed at power-up of the IP client.

6. The method of claim 1, wherein the IP client comprises an IP based communication link for communicating with the gateway server.

7. A method for updating software program files in an IP client, the IP client being connected to a gateway server which is in communication with a head end facility through a network,
the method comprising
storing and broadcasting by the head end facility a list of latest versions available of software program files useable by an IP client,
broadcasting in a scheduled manner the latest version of each software program file by the head end facility.

8. The method of claim 7, wherein broadcasting is executed on a predetermined channel in the network.

9. A method for updating software program files in an IP client, the IP client being connected to a gateway server which is in communication with a head end facility through a network,
the method comprising
providing a list of software program files used in the IP client and the associated version identifiers upon request from the gateway server,
receiving from the gateway server a software program file having a newer version identifier, and storing the software program file, by the IP client.

10. The method of claim 9, wherein receiving the software program is executed when the IP client is in a standby mode.

11. A system for providing media content to one or more IP clients, the one or more IP clients being connected to a gateway server which is in communication with a head end facility through a network,
wherein the, gateway server is connected to a head end facility via the network, the head end facility forming part of a media content delivery system and being arranged to distribute media content to the IP client via the gateway server, wherein the IP client, gateway server and head end facility are arranged to execute
interrogating an IP client connected to the gateway server and receiving from the IP client a current list of software program files including a latest version identifier for each of the software program files, by the gateway server,
receiving by the gateway server from the head end facility a central list of latest version identifiers of software program files executable by the IP client,
comparing the current list with the central list by the gateway server, and
if for a specific software program file a newer version identifier exists,
downloading from the head end facility the software program file associated with the newer version identifier by the gateway server, and
transferring the newer version of the software program file to the IP client by the gateway server.

12. The system according to claim 11, wherein the gateway server comprises one or more tuners.

13. The system according to claim 11, wherein the gateway server receives the software program file associated with the newer version identifier on a broadcast channel in the network.

14-15. (canceled)

16. The system of claim 11, wherein the step of downloading the software program file is executed after the IP client is switched to a stand-by state.

17. The system of claim 16, wherein transferring the newer version of the software program file to the IP client is executed at power-up of the IP client.

18. The system of claim 11, wherein the IP client comprises an IP based communication link for communicating with the gateway server.

19. A system for providing media content to one or more IP clients, the one or more IP clients being connected to a gateway server which is in communication with a head end facility through a network,
wherein the gateway server is connected to a head end facility via the network, the head end facility forming part of a media content delivery system and being arranged to distribute media content to the IP client via the gateway server, wherein the IP client, gateway server and head end facility are arranged to execute
storing and broadcasting by the head end facility a list of latest versions available of software program files useable by an IP client,
broadcasting in a scheduled manner the latest version of each software program file by the head end facility.

20. The system of claim 19, wherein broadcasting is executed on a predetermined channel in the network.

21. A system for providing media content to one or more IP clients, the one or more IP clients being connected to a gateway server which is in communication with a head end facility through a network,
wherein the gateway server is connected to a head end facility via the network, the head end facility forming part of a media content delivery system and being arranged to distribute media content to the IP client via the gateway server, wherein the IP client, gateway server and head end facility are arranged to execute
providing a list of software program files used in the IP client and the associated version identifiers upon request from the gateway server,
receiving from the gateway server a software program file having a newer version identifier, and storing the software program file, by the IP client.

22. The system of claim 21, wherein receiving the software program is executed when the IP client is in a standby mode.

23. The system of claim 11, wherein the gateway server comprises one or more tuners.

24. The system of claim 19, wherein the gateway server comprises one or more tuners.

25. The system of claim 21, wherein the gateway server comprises one or more tuners.

26. The system of claim 11, wherein the gateway server comprises a conditional access unit.

27. The system of claim 19, wherein the gateway server comprises a conditional access unit.

28. The system of claim 21, wherein the gateway server comprises a conditional access unit.

29. A head end facility for providing media content to an IP client
wherein the head end facility is arranged for
storing and broadcasting by the head end facility a list of latest versions available of software program files useable by an IP client,
broadcasting in a scheduled manner the latest version of each software program file by the head end facility.

30. The head end facility of claim 29, wherein broadcasting is executed on a predetermined channel in the network.

31. An IP client for providing media content to a user device, the IP client being connectable to a head end facility through a gateway server and a network, the IP client being arranged for
providing a list of software program files used in the IP client and the associated version identifiers upon request from the gateway server,
receiving from the gateway server a software program file having a newer version identifier, and storing the software program file, by the IP client.

32. The IP client of claim 31, wherein receiving the software program is executed when the IP client is in a standby mode.
